(19) United States
(12) Patent Application Publication
(10) Pub. No.: US 2023/0312388 A1
(43) Pub. Date: Oct. 5, 2023

(54) METHOD OF INCREASING THE STRENGTH AND/OR HARDNESS OF A GLASS ARTICLE

(71) Applicants: TECHNISCHE UNIVERSITÄT BERGAKADEMIE FREIBURG, Freiburg (DE); 2MH GLAS GMBH, Dietzenbach (DE)

(72) Inventors: Thomas VOLAND, Grossweitzchen (DE); Sabine HÖNIG, Dittmannsdorf (DE); Martin GROSS, Pockau-Lengefeld (DE); Heiko HESSENKEMPER, Großschirma (DE)

(21) Appl. No.: 18/024,349

(22) PCT Filed: Sep. 2, 2021
(86) PCT No.: PCT/EP2021/074281

§ 371 Date: Mar. 2, 2023

(30) Foreign Application Priority Data
Sep. 3, 2020 (LU) 102043

(51) Int. Cl. C03B 27/02; C03C 21/00; C03B 27/012; C03C 3/091; A47G 19/22; A47G 19/02

(52) U.S. Cl. CPC C03B 27/02; C03C 21/002; C03B 27/012; C03C 3/091; A47G 19/2205; A47G 19/02; A47G 2400/10

(57) ABSTRACT

The invention relates to methods of increasing the strength, especially the flexural strength, of a glass article produced from a glass material. The method includes the step of heating the glass article to a first temperature above the transformation temperature of the glass material, the step of shock cooling the glass article to a second temperature below the transformation temperature of the glass material, and the step of performing an ion exchange process at the second temperature.

### CROSS-REFERENCE TO RELATED APPLICATIONS

The present application is a national phase entry under 35 USC § 371 of International Application PCT/EP2021/074281 filed Sep. 2, 2021, claiming priority to and benefit of Luxembourgian Patent Application No. 102043 filed Sep. 3, 2020, the entire disclosure of which is incorporated herein by reference.

### FIELD

The disclosure relates to a method for increasing the strength, more particularly the bending fracture strength, of a glass article produced from a glass material, specifically alkali metal-alkaline earth metal silicate glass or borosilicate glass.

The disclosure additionally relates to a glass article produced by the method of the disclosure.

### BACKGROUND

There are a variety of hardening and strengthening methods known for ideally adapting glass, as a versatile high-tech material, to the particular use. The majority of hardening and strengthening methods either can be employed only at great cost and complexity, and/or are reliant on the use of—usually expensive—specialty glass.

For example, it is known practice to increase the fracture strength of glass through what is called thermal prestressing (colloquially also called thermal hardening or heat treatment). In this case the glass workpiece to be strengthened is heated in a kiln to around 600° C. and then rapidly quenched to room temperature. This quenching causes the surface to solidify, and there is little subsequent change in the external dimensions of the component. Compressive stresses are developed at the surface of the glass workpiece, and lead ultimately to a higher fracture strength. The thermal prestressing is employed in particular when producing single-sheet safety glass (toughened safety glass; TSG). The stress profile of single-sheet safety glass exhibits high tensile stresses over the glass thickness in the interior, which in the event of failure of the sheet result in a characteristic crazed appearance.

It is also known practice to strengthen glass articles by chemical prestressing. With chemical prestressing, distinctions are made between methods involving high-temperature ion exchange and methods involving low-temperature ion exchange. Only low-temperature ion exchange methods, entailing the replacement of one alkali metal ion by a larger alkali metal ion, have been employed industrially to date. With these methods, a compressive stress zone at the surface of the glass is achieved by an ion exchange which takes place usually in a bath of molten salt between the glass surface and the salt bath. For example, sodium ions are replaced with potassium ions, producing a compressive stress zone in the glass surface because the potassium ions are larger than the sodium ions. For standard commercial glasses (alkali metal-alkaline earth metal silicate glasses), the treatment time in the salt melt is very long, which is disadvantageous. The time is typically between 8 and 36 hours. The problem of the long process times can be mitigated by the use of expensive specialty glasses in conjunction with the application of complicated, more particularly multistage, treatment methods.

DD 1579 66 discloses a method and an apparatus for the strengthening of glass products by ion exchange. The glass products in this case are strengthened by exchange of alkali metal ions between the glass surface and alkali metal salt melts. The strengthening sees hollow glass products with their opening turned downward, or hollow glass products which are rotated or swiveled about a horizontal axis, being irrigated with the salt melt. In this operation, the salt is continuously circulated and passed through perforated plates to generate a cascaded irrigation for the glass products, which are arranged in multiple layers. Unfortunately, for economic viability, this method can be utilized only with the use of comparatively expensive specialty glass.

DE 195 10 202 C2 discloses a method for producing hollow glass bodies by the blow-and-blow and press-and-blow shaping method with enhanced mechanical strength. A feature of the method is that the blow press air in the parison mold and/or finish mold of the blow-and-blow shaping method or in the finish mold of the press-and-blow shaping method is admixed with mists of aqueous alkali metal salt solutions.

DE 11 2014 003 344 T5 discloses a chemically hardened glass for flat screens of digital cameras, mobile phones, digital organizers, etc. The chemically hardened glass has a compressive stress layer generated by an ion exchange method, with the glass having a surface roughness of 0.20 nm or higher and with the hydrogen concentration Y in the region to a depth X from an outermost surface of the glass satisfying the equation Y=aX+b where X=from 0.1 to 0.4 (μm). The glass is preheated to a temperature of 100° Celsius and then immersed in molten salt.

### SUMMARY

It is the object of the present disclosure to specify a method which makes it possible, with comparatively rapid performability, to strengthen even glass articles which are not produced from expensive and specially adapted specialty glass.

The object is achieved by a method which is characterized by steps as follows:
a. heating of the glass article to a first temperature which lies above the transition temperature of the glass material,
b. shock cooling of the glass article to a second temperature which lies below the transition temperature of the glass material, the shock cooling taking place by contacting of the glass article with a cooling agent which has the second temperature,
c. performing an ion exchange process at the second temperature for a period in the range from 15 minutes to 45 minutes.

The method of the disclosure is based on a skillful combination of thermal and chemical hardening and, in an advantageous and surprising way, can be performed comparatively simply, quickly and straightforwardly. Nevertheless, the method of the disclosure affords both substantial advantages of the thermal prestressing and also substantial advantages of the chemical prestressing.

With the method of the disclosure it is possible more particularly to achieve very high strength values, especially in relation to bending fracture strength, microhardness and scratch resistance, which exceed by a multiple the strength values of untreated glass, but where the process times required are very short by comparison with the process times of typical methods of chemical prestressing. It has emerged that in the case of the method of the disclosure, the ion exchange time will generally need to be less than 30 minutes in order to be able to achieve strength values of similar quality to those achieved by hitherto customary chemical strengthening methods with very long process times, and that better strength values are achieved than in the case of a pure thermal strengthening. The method of the disclosure is therefore suitable with particular advantage for industrial mass production of hardened glass articles.

A further advantage of the method of the disclosure is that it affords a very great flexibility in terms of the possible wall thicknesses and the possible shapes of the glass articles for treatment. The method of the disclosure is suitable not only for increasing the strength of flat glass, for windows or displays, for example, but also for increasing the strength of differently shaped glass articles, more particularly vessels and/or dishware.

The disclosure has, in particular, the very particular advantage that the starting material used may comprise, in particular, comparatively inexpensive glass material, such as simple utility glass, for example, more particularly container glass, to eventually give glass articles that are especially fracture-resistant.

The disclosure additionally has the very particular advantage that particularly for utility articles in daily life, by virtue of the enhanced fracture strength, the required wall thickness of the glass article is lower. This has the consequence that in the production of the glass articles, relative to glass articles produced conventionally from the same glass material, glass can be saved. More particularly, therefore, the glass articles treated in accordance with the disclosure have a lower intrinsic weight than glass articles produced conventionally from the same glass material.

Particularly good results are achieved if the first temperature lies in a range from 100 kelvins to 300 kelvins above the transition temperature. In particular it may be advantageous for the first temperature to lie in a range from 50 kelvins below and 30 kelvins above the Littleton softening point of the glass material.

The transition temperature is the temperature at which the glass as it cools undergoes transition from the plastic range into the rigid state, more particularly the temperature at which the viscosity η is 10^{12.3} Pa s (ten to the power of twelve point three pascals times second).

The Littleton softening point is the temperature at which the viscosity η is 1066 Pa s (pascals times second).

In particular it may be advantageous for the glass article to be heated in such a way that the initial heating rate is 100 kelvins per minute, more particularly more than 250 kelvins per minute.

The heating of the glass article to a first temperature may be accomplished advantageously by transferring the glass article (more particularly together with further glass articles of a batch) into a kiln. The kiln may advantageously have a kiln temperature which corresponds to the Littleton softening point of the glass material or which lies at most 50 kelvins below and at most 30 kelvins above the Littleton softening point of the glass material of the glass article. The kiln may more particularly advantageously have a kiln temperature which lies in a range from 10 kelvins to 40 kelvins above the first temperature. Especially when using alkali-metal alkaline earth metal silicate glass as glass material, the kiln temperature may lie advantageously in the range from 650° Celsius to 770° Celsius, more particularly in the range from 740° Celsius to 760° Celsius or in the range from 680° Celsius to 730° Celsius, or may be 750° Celsius.

It is important to ensure that the glass article remains in the kiln for a sufficient time to reach (at least at its outermost layer) the first temperature. However, the glass article must not remain too long in the kiln, so as to avoid unwanted deformation of the glass article. It has emerged that in the case of glass articles which are embodied as hollow bodies with walls having a wall thickness, particularly good results are achieved if the glass article remains in the kiln for a heating time in the range from 35 seconds to 90 seconds, more particularly from 45 seconds to 70 seconds per millimeter of wall thickness, more particularly for a heating time of 55 seconds per millimeter of wall thickness. In the case of a glass article whose walls have different thicknesses at different points, the wall thickness at the thinnest point is preferably the thickness critical for the heating time. In the case of a glass article which has a flat embodiment and has thickness, particularly good results are achieved if the glass article remains in the kiln for a heating time in the range from 35 seconds to 90 seconds, more particularly from 45 seconds to 70 seconds, per millimeter of thickness, more particularly for a heating time of 55 seconds per millimeter of thickness. In the case of a glass article which has different thicknesses at different points, the thickness at the thinnest point is preferably the thickness critical for the heating time.

Especially in the case of glass articles which have a wall thickness or a thickness of more than 2 millimeters, more particularly of more than 3 millimeters, and/or of glass articles which have very different wall thicknesses or thicknesses in different regions, the heating may take place, in an especially advantageous way, in a multistage, more particularly two-stage, process. In particular it may be advantageous for the glass article to be first heated slowly to an intermediate temperature and then heated rapidly to the first temperature. In particular it may be advantageous for the glass article to be heated first at a first heating rate to an intermediate temperature and then heated to the first temperature at a second heating rate, which is above the first heating rate.

This procedure has the very particular advantage that unwanted deformation of the glass article is effectively avoided, since all regions of the glass article attain the first temperature simultaneously or at least within a specified or specifiable time window. This prevents the situation where the regions of the glass article which can be heated more rapidly undergo (unwanted) deformation even while it is still necessary to wait until other regions, which can be heated up less rapidly, reach the first temperature.

Furthermore, this procedure has the very particular advantage that it prevents or at least reduces interactions that occur at high temperatures in particular between the glass article and the holder that holds and/or transports the glass article during the implementation of the method.

The intermediate temperature lies preferably in a range from 50° Kelvin below to 100 kelvins above the transition temperature of the glass material, more particularly in a range from 0 kelvins to 50 kelvins above the transition temperature of the glass material.

In order to achieve this, the kiln temperature may for example be increased after the first heating phase. An alternative possibility as well is to use two kilns having different kiln temperatures, with the glass article after the first heating phase being transferred for the second heating phase from the first kiln into the second kiln, which has a higher kiln temperature. In one especially advantageous version, a kiln is used which has kiln regions differing in temperature, allowing the glass article after the first heating phase in a first kiln region to be transferred to a second kiln region for the second heating phase.

In particular it is possible advantageously for the glass article to be heated first at a first kiln temperature and thereafter at a second kiln temperature which is higher than the first kiln temperature. In this case it is particularly advantageous if the glass article is exposed to the second kiln temperature for a heating time in the range from 30 seconds to 120 seconds, more particularly from 80 seconds to 100 seconds, or for a heating time of 90 seconds. In this way, the glass article reaches the primary temperature at all points, without any deformation of the glass article occurring.

In the case of alkali metal-alkaline earth metal silicate glass, the upper kiln temperature may lay advantageously in the range from 680° Celsius to 730° Celsius.

In one advantageous version, the shock cooling is performed without delay as soon as the glass article has reached the first temperature. The shock cooling at least takes place preferably with a delay of not more one minute after the glass article has reached the first temperature. This prevents the glass article, heated to the first temperature, initially cooling down again slowly, more particularly to a temperature outside a range from 100 kelvins to 300 kelvins above the transition temperature, before the shock cooling takes place.

Particularly good strength values are achieved if the second temperature lies in a range from 50 kelvins to 200 kelvins below the transition temperature.

In one especially advantageous version, the shock cooling is accomplished by contacting the glass article with a cooling agent, which is a liquid or a suspension.

The cooling agent has the second temperature. The shock cooling may be accomplished in particular by immersing the glass article in a cooling bath which comprises the cooling agent. It is alternatively, for example, also possible for the contacting to be accomplished by spraying or by sprinkling with the cooling agent, which preferably has the second temperature.

In a manner in accordance with the disclosure it has in particular been recognized that particularly good results are achieved if the glass article—in contrast to what is the case with the conventional heat treatment, for example—is quenched not to room temperature, but rather to the second temperature, at which the ion exchange process is also performed. Between the operation of shock cooling by the contacting of the glass article with the cooling agent, and the start of the ion exchange process, there is preferably no time delay and/or renewed heating of the glass article. Such a procedure is particularly efficient and leads to especially good results in terms of the strength, more particularly the bending fracture strength, of the glass article.

It has further been recognized that the initial cooling rate is determined substantially by the difference between primary temperature and the cooling agent temperature and also by the material-specific heat transfer coefficient. Particularly good results in terms of the fracture strength are achieved in particular if the first temperature and the cooling agent temperature are selected such that the initial cooling rate is in the range from 80 kelvins to 120 kelvins per second, more particularly in the range from 90 kelvins to 110 kelvins per second, or is 100 kelvins per second.

The ion exchange process preferably comprises ions, more particularly alkali metal ions, especially sodium ions, being removed from the glass article and replaced by spatially larger ions, more particularly alkali metal ions, very particularly potassium ions. As already mentioned, the ion exchange process preferably comprises contacting the glass article with an exchange agent.

In one especially advantageous version, an exchange agent is used in the form of an exchange salt melt or in the form of a suspension or paste comprising an exchange salt. In this case, in particular, it is advantageous for the exchange salt to be potassium nitride or to comprise potassium nitride.

The contacting of the glass article of the exchange agent may be accomplished in particular by immersion or by spraying or by sprinkling.

In the case of one especially advantageous version, the cooling agent is at the same time also the exchange agent. In particular it is possible advantageously for the glass article, after heating to the first temperature, to be immersed in the exchange agent, which simultaneously functions as the cooling agent, with the shock cooling thereby taking place directly and the ion exchange process beginning directly. This procedure is especially advantageous in relation in particular to a short process time.

In the disclosure, the ion exchange process is performed for a period in the range from 15 minutes to 45 minutes. It has emerged, however, that very high strength values are achieved if the ion exchange process lasts for a period in the range from 20 minutes to 40 minutes, more particularly for around 30 minutes.

The glass material is preferably not aluminosilicate glass, since such glass is too complicated and more particularly too expensive to produce. The glass material preferably has an aluminum oxide fraction of less than 5% (percent by mass) (Al₂O₃<5%), more particularly of less than 4.5% (percent by mass) (Al₂O₃<4,5%).

Alkali metal-alkaline earth metal silicate glass in particular has the particular advantage that it is inexpensively obtainable and yet can be processed with the method of the disclosure to form particularly fracture-resistant glass articles. Especially when using alkali metal-alkaline earth metal silicate glass as glass material, the first temperature may lay advantageously in the range from 700° Celsius to 760° Celsius, more particularly in the range from 720° Celsius to 740° Celsius. Correspondingly, the cooling agent temperature, especially if the cooling agent comprises, for example, a molten salt, such as molten sodium salt or molten potassium salt, for example, may lay advantageously in the range from 350° Celsius to 500° Celsius, more particularly in the range from 390° Celsius to 450° Celsius or in the range from 420° Celsius to 440° Celsius, in particular in order to achieve the advantageous cooling rate stated above.

The glass material may advantageously have a silicon dioxide fraction (SiO₂) of more than 58% (percent by mass) and of less than 85% (percent by mass), more particularly of more than 70% (percent by mass) and of less than 74% (percent by mass). In particular the glass material which is an alkali metal-alkaline earth metal silicate glass may advantageously have a silicon dioxide fraction of more than 70% (percent by mass) and of less than 74% (percent by mass).

Alternatively or additionally, it may be advantageous for the glass material to have an alkali metal oxide fraction, more particularly sodium oxide fraction (Na₂O) and/or lithium oxide fraction (Li₂O), in the range from 5% (percent by mass) to 20% (percent by mass), more particularly in the range from 10% (percent by mass) to 14.5% (percent by mass) or in the range from 12% (percent by mass) to 13.5% (percent by mass).

The glass material may (alternatively or additionally) advantageously have a potassium dioxide fraction (K₂O) of at most 7% (percent by mass), more particularly of at most 3% (percent by mass) or of at most 1% (percent by mass). In particular the glass material may have a potassium oxide fraction in the range from 0.5% (percent by mass) to 0.9% (percent by mass).

Alternatively or additionally it may be advantageous for the glass material to have a boron trioxide fraction (B₂O₃) of less than 15% (percent by mass), more particularly of at most 5% (percent by mass).

As already mentioned, a glass article treated by the method of the disclosure has especially good strength values, although it can be produced from an inexpensive glass material. More particularly it is possible to achieve a strength for the glass article, more particularly to achieve a strength measured according to DIN EN 1288-5, which is at least 1.5 times, more particularly at least twice or at least three times or at least four times or at least five times, higher than the strength of an identical untreated glass article, more particularly of a glass article of identical shape and size and identical glass material.

It has been possible, for example, to show that standard commercial float glass with a thickness of 0.95 mm produced from alkali metal-alkaline earth metal silicate glass as glass material, after treatment according to the disclosure entailing the performance of the 30-minute ion exchange process, exhibits a multiply higher strength, in a double ring bending test according to DIN EN 1288-5, than identical untreated float glass. Float glass having a thickness of 0.95 mm is used, for example, for displays. Specifically, the mean double ring bending tensile strength in the case of the samples of untreated float glass was 550 MPa, whereas the mean double ring bending tensile strength for the samples treated in accordance with the disclosure was 1600 MPa.

With the method of the disclosure, therefore, it is possible for example to achieve strength values which are at least comparable with the strength of conventional display glasses (more particularly display glasses produced from specialty glass and treated with relatively costlier and complicated conventional methods).

The glass article may for example be embodied as a hollow body, more particularly a drinking glass, a vase, a tumbler, a bowl or a bottle. It is also possible for the glass article to be embodied as a dishware article, more particularly as a plate or sheet. The glass article may also be embodied as flat glass, such as for a flat screen, for example.

### BRIEF DESCRIPTION OF THE DRAWING VIEWS

In the drawing, the subject matter of the disclosure is represented illustratively and schematically and is described below with reference to the figures, where elements that are the same or have the same effect, even in different exemplary embodiments, are usually provided with the same reference signs. In the figures,

FIG. 1 shows a representation of the method of the disclosure in relation to the different temperatures during its implementation, and

FIG. 2 shows a representation of the temperature conditions during the implementation of an exemplary embodiment of a method of the disclosure.

### DETAILED DESCRIPTION

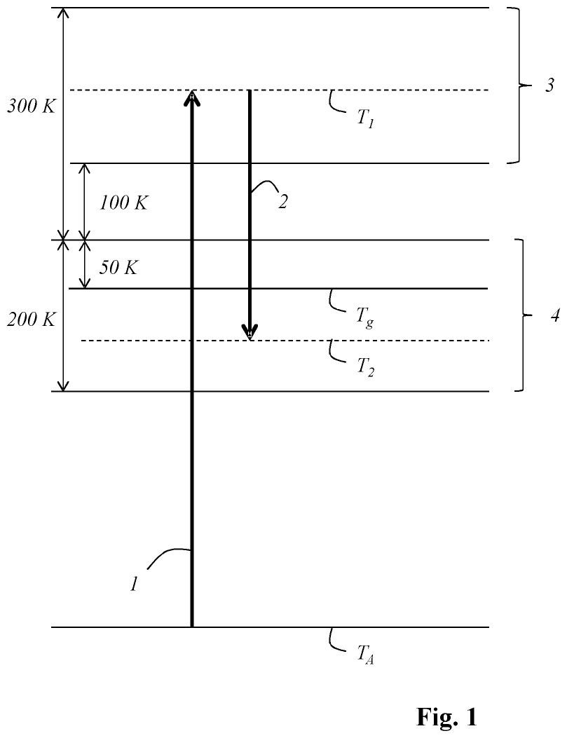

FIG. 1 shows schematically a representation, which not true to scale, of the temperature conditions when the method of the disclosure is performed for increasing the strength, more particularly the bending fracture strength, of a glass article produced from a glass material.

In a first step, there is heating 1 of the glass article from a starting temperature T_{A}, which may for example be the room temperature, to a first temperature T₁, which lies above the transition temperature T_{g} of the glass material of the glass article. The first temperature T₁ preferably lies in a first range 3 from 100 kelvins to 300 kelvins above the transition temperature T_{g} of the glass material.

In a second step, there is shock cooling 2 of the glass article to a second temperature T₂, which lies below the transition temperature T_{g} of the glass material. The second temperature lies preferably in a second range 4 from 50 kelvins to 200 kelvins below the transition temperature T_{g}.

The shock cooling 2 is accomplished preferably by contacting with a cooling agent which has the second temperature T₂ and which at the same time is also an exchange agent for the third step (not represented) of the performance of an ion exchange process at the second temperature T₂.

The ion exchange process is preferably performed for a period in the range from 15 minutes to 300 minutes, more particularly in the range from 20 minutes to 40 minutes, more particularly for around 30 minutes.

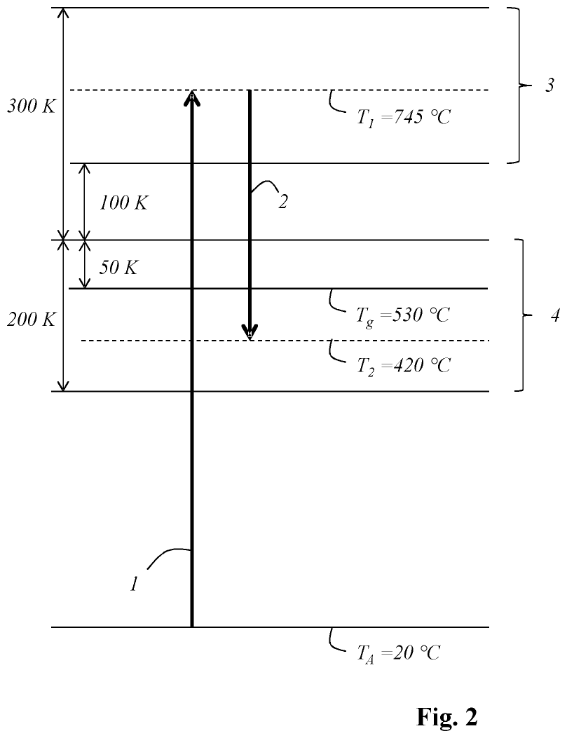

FIG. 2 shows schematically a representation, which is not true to scale, of the temperature conditions when performing an exemplary embodiment of a method of the disclosure for increasing the strength, more particularly the bending fracture strength, of a glass article produced from soda-lime glass.

In a first step, there is heating 1 of the glass article from a starting temperature T_{A}, which may for example be 20° C., in a kiln (not represented), to a first temperature T₁ of 745° C., which lies above the transition temperature T_{g} of 530° C. of the glass material of the glass article.

In a second step there follows directly shock cooling 2 of the glass article to a second temperature T2, which is 420° C. The shock cooling 2 is accomplished by immersing the glass article in a cooling bath (not represented), which as cooling agent comprises a salt melt of potassium nitrate. The salt melt has a temperature of 420° C.

At the same time the salt melt is also the exchange agent for the third step (not represented), of performing an ion exchange process, which is performed at the second temperature T₂ of 420° C. For this, the glass article is left in the salt melt for a period in the range from 15 minutes to 300 minutes, more particularly in the range from 20 minutes to 40 minutes, more particularly for around 30 minutes.

Thereafter the glass article is removed from the cooling bath and cooled further to room temperature in a cooling position outside the cooling bath, and is finally cleaned.

### LIST OF REFERENCE SIGNS

1 Heating
2 Shock cooling
3 First region
4 Second region
T₁ First temperature
T₂ Second temperature
T_{A} Starting temperature
T_{g} Transition temperature

What is claimed is:

1. A method for increasing the strength, more particularly the bending fracture strength, of a glass article produced from a glass material, specifically alkali metal-alkaline earth metal silicate glass or borosilicate glass, characterized by steps as follows:
a. heating of the glass article to a first temperature which lies above the transition temperature of the glass material,
b. shock cooling of the glass article to a second temperature which lies below the transition temperature of the glass material, the shock cooling taking place by contacting of the glass article with a cooling agent which has the second temperature,
c. performing an ion exchange process at the second temperature for a period in the range from 15 minutes to 45 minutes.

2. The method as claimed in claim 1, characterized in that the first temperature lies in a range from 100 kelvins to 300 kelvins above the transition temperature.

3. The method as claimed in claim 1, characterized in that the first temperature lies in a range from 50 kelvins below to 30 kelvins above the Littleton softening point of the glass material.

4. The method as claimed in claim 1, characterized in that the glass article is heated in such a way that the initial heating rate is 100 kelvins per minute, more particularly more than 250 kelvins per minute.

5. The method as claimed in claim 1, characterized in that the shock cooling is performed without delay as soon as the glass article has reached the first temperature, or in that the shock cooling is performed with a delay of not more than one minute after the glass article has reached the first temperature.

6. The method as claimed in claim 1, characterized in that the glass article for heating is transferred into a kiln.

7. The method as claimed in claim 6, characterized in that the kiln has a kiln temperature which lies above the first temperature or in that the kiln has a kiln temperature which lies in a range from 10 kelvins to 40 kelvins above the first temperature.

8. The method as claimed in claim 1, characterized in that the glass article has a thickness and in that the glass article remains in the kiln for a heating time in the range from 35 seconds to 45 seconds per millimeter of thickness, more particularly for a heating time of 40 seconds per millimeter of thickness.

9. The method as claimed in claim 1, characterized in that the glass article is a hollow body with walls which have a wall thickness, and in that the glass article remains in the kiln for a heating time in the range from 35 seconds to 45 seconds per millimeter of wall thickness, more particularly for a heating time of 40 seconds per millimeter of wall thickness.

10. The method as claimed in claim 1, characterized in that the second temperature lies in a range from 50 kelvins to 200 kelvins below the transition temperature.

11. The method as claimed in claim 1, characterized in that the cooling agent is a liquid or a suspension.

12. The method as claimed in claim 1, characterized in that the shock cooling takes place by immersion of the glass article in a cooling bath which contains the cooling agent, or by spraying or by sprinkling with the cooling agent.

13. The method as claimed in claim 1, characterized in that the first temperature and the cooling agent temperature of the cooling agent are selected in such a way that the initial cooling rate is in the range from 80 kelvins to 120 kelvins per second, more particularly in the range from 90 kelvins to 110 kelvins per second, or is 100 kelvins per second.

14. The method as claimed in claim 1, characterized in that the ion exchange process comprises removing ions, more particularly alkali metal ions, very particularly sodium ions, from the glass article and replacing them by spatially larger ions, more particularly alkali metal ions, very particularly potassium ions.

15. The method as claimed in claim 1, characterized in that the ion exchange process comprises contacting the glass article with an exchange agent, more particularly with an exchange agent which has the second temperature.

16. The method as claimed in claim 15, characterized in that the exchange agent is used in the form of an exchange salt melt or in the form of a suspension or paste containing an exchange salt.

17. The method as claimed in claim 16, characterized in that the exchange salt is potassium nitrate or comprises potassium nitrate.

18. The method as claimed in claim 16, characterized in that contacting of the glass article with the exchange agent takes place by immersion or by spraying or by sprinkling.

19. The method as claimed in claim 15, characterized in that the cooling agent is at the same time also the exchange agent.

20. The method as claimed in claim 1, characterized in that the ion exchange process is performed for a period in the range from 20 minutes to 40 minutes.

21. The method as claimed in claim 1, characterized in that the glass material is not aluminosilicate glass.

22. The method as claimed in claim 1, characterized in that the glass material has an aluminum oxide fraction of less than 5% (percent by mass), more particularly of less than 4.5% (percent by mass).

23. The method as claimed in claim 1, characterized in that the glass material has a silicon dioxide fraction of more than 58% (percent by mass) and of less than 85% (percent by mass), more particularly of more than 70% (percent by mass) and of less than 74% (percent by mass).

24. The method as claimed in claim 1, characterized in that the glass material has an alkali metal oxide fraction, more particularly sodium oxide fraction and/or lithium oxide fraction, in the range from 5% (percent by mass) to 20% (percent by mass), more particularly in the range from 10% (percent by mass) to 14.5% (percent by mass) or in the range from 12% (percent by mass) to 13.5% (percent by mass).

25. The method as claimed in claim 1, characterized in that the glass material has a potassium oxide fraction of at most 7% (percent by mass), more particularly of at most 3% (percent by mass) or of at most 1% (percent by mass), or in that the glass material has a potassium oxide fraction in the range from 0.5% (percent by mass) to 0.9% (percent by mass).

26. The method as claimed in claim 1, characterized in that the glass material has a boron trioxide fraction of less than 15% (percent by mass), more particularly of at most 5% (percent by mass).

27. A glass article produced by means of a method as claimed in claim 1.

28. The glass article as claimed in claim 27, characterized in that the glass article is embodied as a hollow body, more particularly a drinking glass, a vase, a tumbler, a bowl or a bottle.

29. The glass article as claimed in claim 27, characterized in that the glass article is embodied as a dishware article, more particularly as a plate.

30. The glass article as claimed in claim 27, characterized in that the glass article is embodied as a flat glass sheet.
